(19) United States
(12) Patent Application Publication
(10) Pub. No.: US 2025/0348341 A1
(43) Pub. Date: Nov. 13, 2025

(54) RESOURCE MANAGEMENT USING VIRTUALIZATION OF REAL-TIME CLOCKING IN VIRTUAL MACHINES

(71) Applicant: International Business Machines Corporation, Armonk, NY (US)

(72) Inventors: Kathryn Lafser, Vernon Hills, IL (US); Roger W. Rogers, Lafayette, IN (US); Gustavo Eduardo Tejeda Guillemin, Guadalajara (MX); Clay Kaiser, Beacon, NY (US); Stephen Robert Guendert, Murfreesboro, TN (US)

(21) Appl. No.: 18/595,707

(22) Filed: Mar. 5, 2024

(51) Int. Cl. G06F 9/455; G06F 1/08

(52) U.S. Cl. CPC G06F 9/45558; G06F 1/08; G06F 2009/45579

(57) ABSTRACT

Examples described herein provide a computer-implemented method that includes receiving a plurality of profiles corresponding to at least one of a plurality of virtual machines. Each of the plurality of profiles defines a validity period and an allowable variation of time. The method further includes determining, based at least in part on the validity period, a subset of the plurality of profiles that are active. The method further includes calculating a uniform distribution for virtual clocks of each of the subset of the plurality of virtual machines and determining a desired offset. The method further includes adjusting a virtual clock frequency of a virtual clock based at least in part on the desired offset and the allowable variation of time. The adjusting causes a difference between a real time-of-day clock and a virtual time-of-day clock of the at least one of the virtual clocks to increase.

### BACKGROUND

The present disclosure relates to virtual machines, and more specifically, to resource management using virtualization of real-time clocking (TOD) in virtual machine systems.

Virtual machines (VMs) are software-based representations of physical computers that operate independently within a shared physical hardware environment, referred to a “host system,” “physical machine,” or “physical computer.” VMs share the physical resources of the shared physical hardware environment and provide a virtual environment that is isolated from the underlying physical machine and/or other VMs.

A hypervisor, also known as a virtual machine monitor (VMM), is used to manage VMs. The hypervisor acts as a layer of abstraction between the physical hardware of the shared physical hardware environment and the virtualized operating systems of the VMs, providing for multiple VMs to run simultaneously on the same shared physical hardware environment. The hypervisor allocates resources, such as processing resources, memory resources, and storage resources, to each VM and ensures they operate securely and efficiently. Using the allocated resources, each VM can perform various tasks, such as processing, data storage, and/or the like, including combinations and/or multiples thereof. For example, a VM can execute applications that run on the virtualized operating system of the VM using the allocated resources of the shared physical hardware environment.

Many existing virtual environments utilize time-of-day (TOD) clocks to track current time and date within virtualized environments. TOD clocks provide a reference point for temporal operations within virtual machines, such as scheduling tasks, logging events, maintaining synchronization with external systems, and/or the like, including combinations and/or multiples thereof. Most virtual machine hypervisors ensure the TOD clock observed by a virtual machine accurately represents the actual time of day of the host system.

### SUMMARY

In one embodiment, a computer-implemented method is provided. The method includes receiving a plurality of profiles. Each of the plurality of profiles corresponds to at least one of a plurality of virtual machines. The plurality of virtual machines execute on a physical machine sharing physical resources among the plurality of virtual machines. Each of the plurality of profiles defines a validity period and an allowable variation of time. The method further includes determining, based at least in part on the validity period, a subset of the plurality of profiles that are active. The subset of the plurality of profiles that are active defines a subset of the plurality of virtual machines corresponding to the subset of the plurality of profiles. The method further includes calculating a uniform distribution for virtual clocks of each of the subset of the plurality of virtual machines and determining a desired offset. The method further includes adjusting, for at least one of the virtual clocks, a virtual clock frequency based at least in part on the desired offset and the allowable variation of time for at least one virtual machine corresponding to the at least one of the virtual clocks. The adjusting causes a difference between a real time-of-day clock and a virtual time-of-day clock of the at least one of the virtual clocks to increase.

In another embodiment, a system is provided. The system includes a memory comprising computer readable instructions and a processing device for executing the computer readable instructions, the computer readable instructions controlling the processing device to perform operations. The operations include receiving a plurality of profiles, each of the plurality of profiles corresponding to at least one of a plurality of virtual machines, the plurality of virtual machines executing on a physical machine sharing physical resources among the plurality of virtual machines, each of the plurality of profiles defining a validity period and an allowable variation of time. The operations further include determining, based at least in part on the validity period, a subset of the plurality of profiles that are active, the subset of the plurality of profiles that are active defining a subset of the plurality of virtual machines corresponding to the subset of the plurality of profiles. The operations further include calculating a uniform distribution for virtual clocks of each of the subset of the plurality of virtual machines and determining a desired offset. The operations further include adjusting, for at least one of the virtual clocks, a virtual clock frequency based at least in part on the desired offset and the allowable variation of time for at least one virtual machine corresponding to the at least one of the virtual clocks, wherein the adjusting causes a difference between a real time-of-day clock and a virtual time-of-day clock of the at least one of the virtual clocks to increase.

In yet another embodiment, a computer program product is provided. The computer program product includes a set of one or more computer-readable storage media and program instructions, collectively stored in the set of one or more storage media, for causing a processor set to perform the following computer operations. The operations include receiving a plurality of profiles, each of the plurality of profiles corresponding to at least one of a plurality of virtual machines, the plurality of virtual machines executing on a physical machine sharing physical resources among the plurality of virtual machines, each of the plurality of profiles defining a validity period and an allowable variation of time. The operations further include determining, based at least in part on the validity period, a subset of the plurality of profiles that are active, the subset of the plurality of profiles that are active defining a subset of the plurality of virtual machines corresponding to the subset of the plurality of profiles. The operations further include calculating a uniform distribution for virtual clocks of each of the subset of the plurality of virtual machines and determining a desired offset. The operations further include adjusting, for at least one of the virtual clocks, a virtual clock frequency based at least in part on the desired offset and the allowable variation of time for at least one virtual machine corresponding to the at least one of the virtual clocks, wherein the adjusting causes a difference between a real time-of-day clock and a virtual time-of-day clock of the at least one of the virtual clocks to increase.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a computing environment, according to an embodiment;

FIG. 2 illustrates a physical machine executing virtual machines, the physical machine providing for resource management using virtualization of real-time clocking in the virtual machines, according to an embodiment;

FIG. 3 illustrates a hypervisor that includes a clock steering engine, which provides for resource management using virtualization of real-time clocking in the virtual machines, according to an embodiment; and

FIG. 4 illustrates a flowchart of a method for resource management using virtualization of real-time clocking in virtual machines, according to an embodiment.

The detailed description explains embodiments of the disclosure, together with advantages and features, by way of example with reference to the drawings.

### DETAILED DESCRIPTION

One or more embodiments described herein provide for resource management using virtualization of real-time clocking in virtual machine systems. As described herein, most virtual machine hypervisors ensure the TOD clock observed by a virtual machine accurately represents the actual time of day of the host. In many cases, it is desirable to maintain tight TOD synchronization between a host system and the VMs executing on the host system. Tight TOD synchronization refers to precise alignment of clocks across a VM and its host system.

However, tight TOD synchronization may prove problematic when many tasks are scheduled on VMs to run at the same time of day, which may strain system resources of the host system. For example, where multiple VMs each have one or more tasks scheduled for the same time and day, the host system needs to have resources available to satisfy each of these tasks; otherwise, failures may occur. For many workloads, tight TOD synchronization is not necessary. For example, many workloads may be scheduled to run at a particular time (e.g., outside standard business hours) merely for convenience. Such scheduling can be problematic for resource management (e.g., processing resource management, memory resource management, storage resource management, bandwidth management, and/or the like, including combinations and/or multiples thereof) because many tasks may run at the same time, thus causing a simultaneous demand for system resources on the host system from multiple VMs.

In many cases, merely changing the time and day that certain tasks/events occur is impractical. For example, such tasks/events can be so numerous as to make manually changing the time and day overwhelming, tedious, and error prone. As another example, some tasks/events are hardcoded to occur at specific days and times, which cannot be easily changed. As yet another example, using waits/delays/priorities to host system manage resources during peak times requires significant overhead in terms of management and oversight.

One or more embodiments described herein address these and other shortcomings by providing for virtualization of real-time clocking in virtual machine systems to manage host system resources. Particularly, embodiments described herein provide for steering the time-of-day clocks observed by a cohort of VMs or workloads running on the same host system to decouple tightly synchronized cyclical tasks. A hypervisor running on a host system can cause virtual clocks of VMs to speed up or slow down, thereby varying the times at which tasks are performed or events occur on VMs relative to a real TOD. An administrative user can specify profiles defining validity periods and allowable variation of time for the various VMs. A validity period specifies the time during which a profile is active/valid (e.g., the time during which the profile is enforced). An allowable variation of time specifies how much a virtual clock can vary from the real TOD. The hypervisor can use the profiles to speed up or slow down virtual clocks of VMs, thereby implementing virtualization of real-time clocking in virtual machine systems to manage host system resources.

According to one or more embodiments, the functioning of the host system is improved through implementing virtualization of real-time clocking in VMs by speeding up and/or slowing down virtual clocks of the VMs. More particularly, certain tasks/events can be spread out over a period of time, thereby reducing or preventing overloading system resources of the host system.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

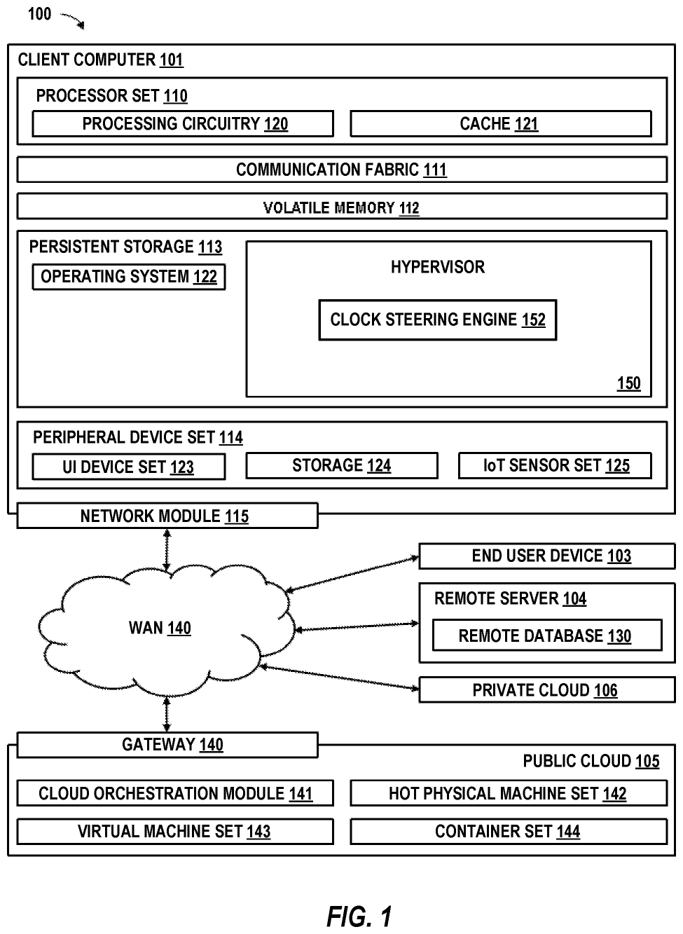

FIG. 1 illustrates a computing environment 100, according to an embodiment. Computing environment 100 contains an example of an environment for the execution of at least some of the computer code involved in performing the inventive methods, such as a hypervisor 150 that includes a clock steering engine 152. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

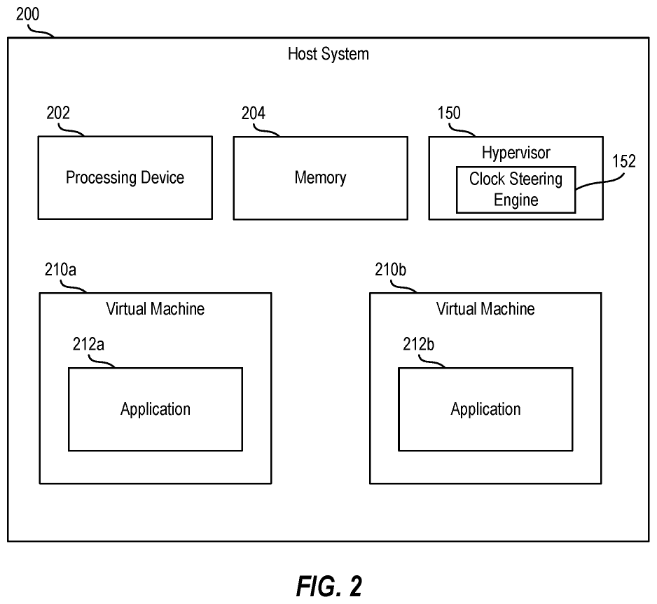

FIG. 2 illustrates a host system 200 executing virtual machines 210a, 210b (collectively referred to as “virtual machines 210”). The host system 200 provides for resource management using virtualization of real-time clocking in the virtual machines 210, according to an embodiment. The host system 200 is an example of a shared physical hardware environment for sharing resources (e.g., processing resources, memory resources, storage resources, and/or the like, including combinations and/or multiples thereof) with one or more virtual machines 210. For example, the host system 200 includes a processing device 202 and a memory 204, although the host system 200 can include additional and/or alternative physical resources in other embodiments. The virtual machines 210a, 210b use the resources of the host system 200 to perform tasks, such as executing applications 212a, 212b, respectively. The applications 212a, 212b can be any suitable application or set of instructions.

The processing device 202 is any suitable processing circuitry for processing data and/or instructions. For example, the processing device 202 can provide processing capabilities for one or more of the virtual machines 210. The processing device 202 is an example of the processor set 110 and/or the processing circuitry 120.

The memory 204 is any suitable device for storing data and/or instructions. For example, the memory 204 can provide temporary and/or persistent data storage capabilities for one or more of the virtual machines 210. The memory 204 is an example of the volatile memory 112 of FIG. 1.

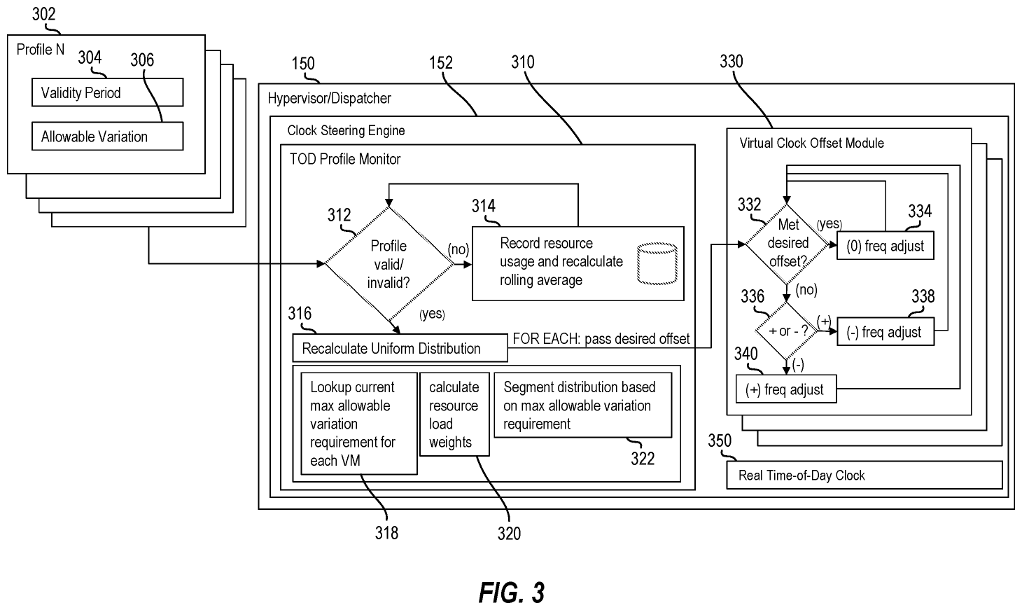

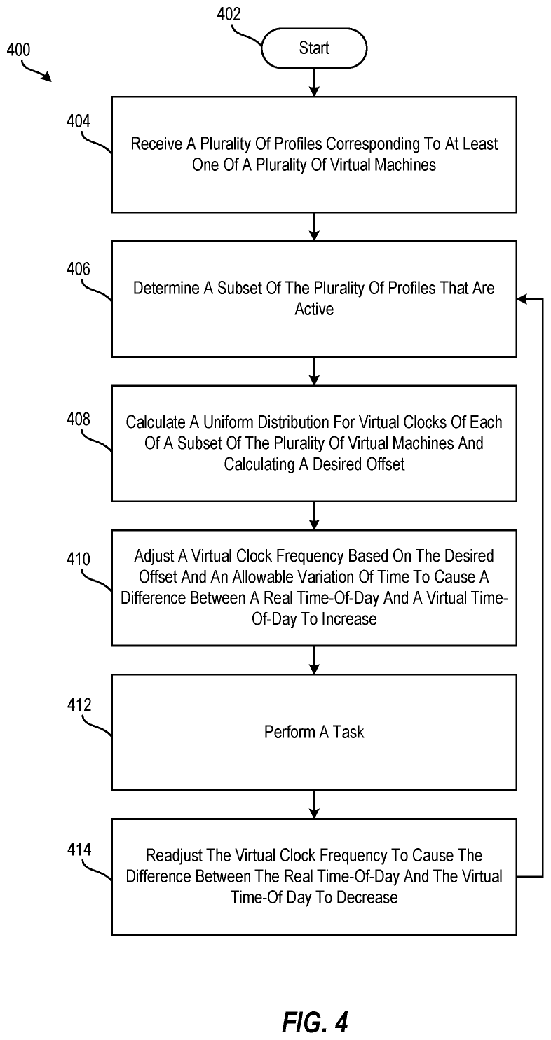

The host system 200 can also include the hypervisor 150 that includes the clock steering engine 152, which provides for virtualization of real-time clocking in the virtual machines 210. It should be appreciated that the clock steering engine 152 can be implemented integral to or as a component of the hypervisor 150 or other virtual machine monitor used to manage the virtual machines 210. Further features of the clock steering engine 152 are now described with reference to FIGS. 3 and 4.

Particularly, FIG. 3 depicts the hypervisor 150 that includes the clock steering engine 152, which provides for resource management using virtualization of real-time clocking in the virtual machines, according to an embodiment.

According to one or more embodiments, as part of a virtual machine hypervisor configuration, an administrator can specify allowable time variance profiles for use with a cohort of virtual machines running on a host system. In the example of FIG. 3, “N” profiles 302 are created. The hypervisor 150 continuously tracks variance requirements for each running VM to create a weighted uniform distribution to spread virtual clocks for each running VM while also maintaining defined bounds specified in the time variance profiles. According to one or more embodiments, a distribution other than a weighted uniform distribution can be used, such as a Gaussian (normal) distribution, a Poisson distribution, a beta distribution, and/or the like, including combinations and/or multiples thereof.

The profiles 302 each define a validity period 304 and an allowable variation of time 306. As described herein, the validity period specifies the time during which a profile is active/valid (e.g., the time during which the profile is enforced), and the allowable variation of time specifies how much a virtual clock can vary from the real TOD. Multiple profiles with varying validity periods 304 and allowable variances of time 306 can be active at the same time for the hypervisor 150. According to one or more embodiments, a single profile is valid for each VM at any given time. At any moment that no profile is valid for a VM, real-time accuracy of time is provided using a real time-of-day clock 350.

The hypervisor 150, using the clock steering engine 152, continuously tracks requirements for each VM to create a weighted uniform distribution in which to distribute virtual clocks of the respective VMs while also maintain bounds defined in the corresponding active profile, namely the validity period 304 and the allowable variation of time 306.

A TOD profile monitor 310 of the clock steering engine 152 receives the profiles 302 and determines whether each of the profiles is valid or invalid at block 312. A profile is considered valid if the current time, as determined using the real time-of-day clock 350, is within the validity profile 302 defined by the profile. For example, if a profile's validity period 304 is 01:00 am-02:00 am, and the real time-of-day clock 350 indicates that the time is currently 01:37 am, the profile is valid. If no profiles 302 are valid (block 312 “no”), resource usage of the VMs is recorded at block 314, and a rolling average of the resource usage is calculated. The rolling average can be for a discrete time period (e.g., one hour, one day, one week, and/or the like).

If one or more of the profiles 302 are valid (block 312 “yes”), a uniform distribution is calculated (or recalculated), and a desired offset is assigned. The uniform distribution calculation provides for spreading out units of resources that each VM is using so that the resource usage can be spread out over a larger period of time to manage system resources. The uniform distribution (or any other suitable distribution) is calculated based at least in part on a current maximum allowable variation requirement for each VM (block 318), resource load weights (block 320), and a segment distribution based on the maximum allowable variation requirement for each VM (block 322). The current maximum allowable variation requirement is a maximum amount of allowable variation in terms of time that is permissible for a particular VM. The resource load weights are the amount of the host system's resources, in terms of load (e.g., how much processing resource), used by each VM. The loads can be weighted, for example, based on priority, importance, customer service agreements, etc., of the VM, the tasks being performed, and/or the system resources being used. Segmenting the distribution can begin with a tightest segment and then place VMs uniformly into each of multiple segments to minimize overlap, where spacing between VMs can be based on load weight, for example. As described herein, a distribution other than a weighted uniform distribution can be used in various embodiments, such as a Gaussian (normal) distribution, a Poisson distribution, a beta distribution, and/or the like, including combinations and/or multiples thereof. In this way, the “shape” of the distribution is flexible. Segmenting can be performed in any advantageous way depending on the type of distribution used. That is, different approaches to segmenting can be implemented for different types of distributions.

Responsive to the calculated uniform distribution at block 316 for each VM, a desired offset for each VM is passed to a virtual clock offset module 330. The virtual clock offset module 330 varies the frequency of virtual clocks of VMs based on the desired offset from the uniform distribution and the allowable variation 306 for the VM. If the desired offset is met (block 332 “yes”), the virtual clock frequency remains constant at block 334. In other words, if the desired offset is met, the frequency is not adjusted. If, however, the desired offset is not met (block 332 “no”), the frequency is increased or decreased, depending on whether the virtual clock is ahead (+) or behind (−) the real time-of-day clock 350. If the virtual clock is ahead (block 366 “(+)”), the virtual clock frequency is decreased at block 338. If, however, the virtual clock is behind (block 366 “(−)”), the virtual clock frequency is increased at block 340.

Once a profile becomes invalid, the virtual clocks for the VMs corresponding to the profile are adjusted back to the real time using the real time-of-day clock 350.

FIG. 4 illustrates a flowchart of a method 400 for resource management using virtualization of real-time clocking in VMs (e.g., the virtual machines 210 of FIG. 2), according to an embodiment. The method 400 can be performed by any suitable computing system, device, or environment, such as those described herein.

The method 400 begins at block 402 at proceeds to block 404. At block 404, the hypervisor 150 receives a plurality of profiles corresponding to at least one of a plurality of VMs (e.g., the virtual machines 210). For example, one profile can correspond to one VM (e.g., the virtual machine 210a) or to multiple VMs (e.g., the virtual machines 210a, 210b). As described with respect to FIG. 2, the plurality of VMs execute on a physical machine (e.g., the host system 200) sharing physical resources (e.g., the processing device 202, the memory 204) among the plurality of VMs. Each of the plurality of profiles defines a validity period and an allowable variation of time. The validity period specifies the time during which a profile is active/valid (e.g., the time during which the profile is enforced). The allowable variation of time specifies how much a virtual clock can vary from the real TOD.

At block 406, the clock steering engine 152 of the hypervisor 150 determines a subset of the plurality of profiles that are active. For example, the clock steering engine 152 compares the validity period for each of the profiles to a current TOD, and any profiles matching the current TOD are considered active. The subset of the plurality of profiles that are active defines a subset of the plurality of VMs corresponding to the subset of the plurality of profiles. That is, the VMs included in a profile that is active are considered the subset of the plurality of profiles.

At block 408, the clock steering engine 152 calculates a uniform distribution of virtual clocks of each of the subset of the plurality of VMs (e.g., the virtual machines 210). That is, the uniform distribution of virtual clocks is calculated for virtual clocks of the VMs that are included in a profile that is active. A virtual clock is a clock associated with a VM and tracks time for the VM. Also at block 408, the clock steering engine 152 determines a desired offset. The desired offset is an amount of time to offset the VMs virtual clock relative to the real TOD (e.g., the real time-of-day clock 350). The desired offset can be determined by looking up a current maximum allowable variation requirement for each VM (block 318 of FIG. 3), by calculating resource load weights (block 320 of FIG. 3), and by segmenting distribution based on the maximum allowable variation requirement for each VM (block 322 of FIG. 3).

At block 410, the clock steering engine 152 adjusts a virtual clock frequency based on the desired offset and the allowable variation of time (defined by the profile at block 404) to cause a difference between the real TOD clock (e.g., of the host system 200) and a virtual TOD clock (e.g., of the VM 210a) to increase. As described with reference to FIG. 3, adjusting the virtual clock frequency can include increasing the frequency of the virtual clock to speed up the virtual clock relative to the clock of the host system and/or can include decreasing the frequency of the virtual clock to slow down the virtual clock relative to the clock of the host system.

At block 412, subsequent to the adjusting the virtual clock frequency, the VM performs a task. The task can be any suitable action, such as causing an application (e.g., one of the applications 212a, 212b) to execute, logging information, triggering another system to perform an action, and/or the like, including combinations and/or multiples thereof.

At block 414, subsequent to performing the task, the clock steering engine 152 readjusts the virtual clock frequency to cause a difference between the real TOD clock (e.g., the real time-of-day clock 350) and the virtual clock of the at least one the virtual clocks to decrease. That is, an adjustment opposite the adjustment at block 410 is performed at block 414 to return the virtual clock into synchronization with the real TOD clock. According to one or more embodiments, the adjustment at block 414 can cause the difference between the real TOD clock and the virtual clock to decrease to substantially zero, thereby providing for synchronization.

According to one or more embodiments, if it is determined that none of the plurality of profiles are active at block 406, the clock steering engine 152 of the hypervisor 150 determines a resource usage of resources of the host system 200 by the VMs and calculates a rolling average of the resource usage by the VMs. According to one or more embodiments, the resource usage is a measure of how much of a system resource is used at a particular time. The system resource can be one or more of a processing resource (e.g., the processing device 202), a memory resource (e.g., the memory 204), a storage resource and a bandwidth resource.

Additional processes also may be included, and it should be understood that the processes depicted in FIG. 4 represent illustrations, and that other processes may be added or existing processes may be removed, modified, or rearranged without departing from the scope of the present disclosure. It should also be understood that the processes depicted in FIG. 4 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method comprising:
receiving a plurality of profiles, each of the plurality of profiles corresponding to at least one of a plurality of virtual machines, the plurality of virtual machines executing on a physical machine sharing physical resources among the plurality of virtual machines, each of the plurality of profiles defining a validity period and an allowable variation of time;
determining, based at least in part on the validity period, a subset of the plurality of profiles that are active, the subset of the plurality of profiles that are active defining a subset of the plurality of virtual machines corresponding to the subset of the plurality of profiles;
calculating a uniform distribution for virtual clocks of each of the subset of the plurality of virtual machines and determining a desired offset; and
adjusting, for at least one of the virtual clocks, a virtual clock frequency based at least in part on the desired offset and the allowable variation of time for at least one virtual machine corresponding to the at least one of the virtual clocks, wherein the adjusting causes a difference between a real time-of-day clock and a virtual time-of-day clock of the at least one of the virtual clocks to increase.

2. The computer-implemented method of claim 1, further comprising, subsequent to the adjusting the virtual clock frequency, performing, by the at least one virtual machine corresponding to the at least one of the virtual clocks, a task.

3. The computer-implemented method of claim 2, further comprising, subsequent to performing the task, readjusting the virtual clock frequency, wherein the readjusting causes a difference between the real time-of-day clock and the virtual time-of-day clock of the at least one the virtual clocks to decrease.

4. The computer-implemented method of claim 2, further comprising, subsequent to performing the task, readjusting the virtual clock frequency, wherein the readjusting causes a difference between the real time-of-day clock and the virtual time-of-day clock of the at least one of the virtual clocks to decrease to substantially zero.

5. The computer-implemented method of claim 1, responsive to determining that none of the plurality of profiles are active, determining a resource usage by the plurality of virtual machines and calculating a rolling average of the resource usage by the plurality of virtual machines.

6. The computer-implemented method of claim 5, wherein the resource usage is a measure of how much of a system resource is used at a particular time, wherein the system resource is one of a processing resource, a memory resource, a storage resource and a bandwidth resource.

7. The computer-implemented method of claim 1, wherein the adjusting comprises increasing the virtual clock frequency to speed up the at least one virtual clock.

8. The computer-implemented method of claim 1, wherein the adjusting comprises decreasing the virtual clock frequency to slow down the at least one virtual clock.

9. A system comprising:
a memory comprising computer readable instructions; and
a processing device for executing the computer readable instructions, the computer readable instructions controlling the processing device to perform operations comprising:
receiving a plurality of profiles, each of the plurality of profiles corresponding to at least one of a plurality of virtual machines, the plurality of virtual machines executing on a physical machine sharing physical resources among the plurality of virtual machines, each of the plurality of profiles defining a validity period and an allowable variation of time;
determining, based at least in part on the validity period, a subset of the plurality of profiles that are active, the subset of the plurality of profiles that are active defining a subset of the plurality of virtual machines corresponding to the subset of the plurality of profiles;
calculating a uniform distribution for virtual clocks of each of the subset of the plurality of virtual machines and determining a desired offset; and
adjusting, for at least one of the virtual clocks, a virtual clock frequency based at least in part on the desired offset and the allowable variation of time for at least one virtual machine corresponding to the at least one of the virtual clocks, wherein the adjusting causes a difference between a real time-of-day clock and a virtual time-of-day clock of the at least one of the virtual clocks to increase.

10. The system of claim 9, further comprising, subsequent to the adjusting the virtual clock frequency, performing, by the at least one virtual machine corresponding to the at least one of the virtual clocks, a task.

11. The system of claim 10, further comprising, subsequent to performing the task, readjusting the virtual clock frequency, wherein the readjusting causes a difference between the real time-of-day clock and the virtual time-of-day clock of the at least one the virtual clocks to decrease.

12. The system of claim 10, further comprising, subsequent to performing the task, readjusting the virtual clock frequency, wherein the readjusting causes a difference between the real time-of-day clock and the virtual time-of-day clock of the at least one of the virtual clocks to decrease to substantially zero.

13. The system of claim 9, responsive to determining that none of the plurality of profiles are active, determining a resource usage by the plurality of virtual machines and calculating a rolling average of the resource usage by the plurality of virtual machines.

14. The system of claim 13, wherein the resource usage is a measure of how much of a system resource is used at a particular time, wherein the system resource is one of a processing resource, a memory resource, a storage resource and a bandwidth resource.

15. The system of claim 9, wherein the adjusting comprises increasing the virtual clock frequency to speed up the at least one virtual clock.

16. The system of claim 9, wherein the adjusting comprises decreasing the virtual clock frequency to slow down the at least one virtual clock.

17. A computer program product comprising:
a set of one or more computer-readable storage media;
program instructions, collectively stored in the set of one or more storage media, for causing a processor set to perform the following computer operations:
receive a plurality of profiles, each of the plurality of profiles corresponding to at least one of a plurality of virtual machines, the plurality of virtual machines executing on a physical machine sharing physical resources among the plurality of virtual machines, each of the plurality of profiles defining a validity period and an allowable variation of time;
determine, based at least in part on the validity period, a subset of the plurality of profiles that are active, the subset of the plurality of profiles that are active defining a subset of the plurality of virtual machines corresponding to the subset of the plurality of profiles;
calculate a uniform distribution for virtual clocks of each of the subset of the plurality of virtual machines and determining a desired offset; and
adjust, for at least one of the virtual clocks, a virtual clock frequency based at least in part on the desired offset and the allowable variation of time for at least one virtual machine corresponding to the at least one of the virtual clocks, wherein the adjusting causes a difference between a real time-of-day clock and a virtual time-of-day clock of the at least one of the virtual clocks to increase.

18. The system of claim 17, the computer operations further comprising, subsequent to the adjusting the virtual clock frequency, perform, by the at least one virtual machine corresponding to the at least one of the virtual clocks, a task.

19. The system of claim 18, the computer operations further comprising, subsequent to performing the task, readjust the virtual clock frequency, wherein the readjusting causes a difference between the real time-of-day clock and the virtual time-of-day clock of the at least one the virtual clocks to decrease.

20. The system of claim 18, the computer operations further comprising, subsequent to performing the task, readjust the virtual clock frequency, wherein the readjusting causes a difference between the real time-of-day clock and the virtual time-of-day clock of the at least one of the virtual clocks to decrease to substantially zero.
